(19) United States
(12) Patent Application Publication
(10) Pub. No.: US 2009/0230054 A1
(43) Pub. Date: Sep. 17, 2009

(54) Contaminant Removal System And Method For A Body Of Water

(76) Inventor: Thomas A. DeBusk, Cocoa, FL (US)

Correspondence Address: JACQUELINE E. HARTT, PH. D.;LOWNDES DROSDICK DOSTER KANTOR & REED, P.A., P.O. BOX 2809, ORLANDO, FL, 32802-2809, US

(21) Appl. No.: 12/413,804

(22) Filed: Mar. 30, 2009

Related U.S. Application Data
(63) Continuation-in-part of application No. 11/363,989, filed on Feb. 28, 2006, now Pat. No. 7,510,660.
(60) Provisional application No. 61/119,443, filed on Dec. 3, 2008.

(51) Int. Cl. C02F 1/52; C02F 3/32

(52) U.S. Cl. 210/602; 210/711

(57) ABSTRACT

Pollutants, such as heavy metals, phosphorus, and pathogenic organisms, are removed from water by adding a chemical coagulant to water within an enclosure. With mixing, coagulation and flocculation occur, and a floc containing the pollutant settles to the enclosure bottom; so the treated water above the floc is free from at least some of the pollutant. The water and the settled floc are mixed to resuspend floc components containing additional contaminant-removal capability. In an alternate system, the floc can be removed from the enclosure, dried, and added back to the enclosure to employ additional contaminant-removal capability. In another system, treated water is exposed to a pH buffering agent to reduce acidity therein.

### CROSS-REFERENCE TO RELATED APPLICATIONS

This patent application claims priority to provisional patent application Ser. No. 61/119,443, filed Dec. 3, 2008, and is a continuation-in-part of application Ser. No. 11/363,989, filed Feb. 28, 2006, issued U.S. Pat. No. 7,510,660, which itself is a continuation-in-part of application Ser. No. 10/656,545, filed Sep. 5, 2003, issued U.S. Pat. No. 7,014,776.

### BACKGROUND OF THE INVENTION

1. Field of the Invention

The present invention relates to systems and methods of water purification, and, more particularly, the control of nutrients, suspended and filamentous algae, pollutants, and toxins in water.

2. Description of Related Art

Many freshwater lakes and ponds, as well as estuaries, are characterized, particularly during the warmer months, by certain contaminants, such as dissolved color, suspended solids, phosphorus, nitrogen, oxygen-demanding substances, pathogenic organisms, and metals.

Chemical coagulants often are used in water treatment to remove contaminants from the water. In lake water treatment, for example, entire lakes or ponds may be treated with coagulants (typically the aluminum compound “alum”). These are added at or above a “critical” concentration, dictated by water chemical characteristics such as water pH and alkalinity, so that a floc forms. Contaminants in the water column are then encapsulated by, or adsorbed to, the floc, which then settles to the bottom of the lake.

It is also known in the art to treat wastewater and drinking waters with conventional “concrete and steel” chemical technologies, using separate chambers for: (1) adding and mixing coagulant; (2) rapid mixing to form flocs; and (3) clarifying to permit settling of flocs, subsequently allowing a clear supernatant to flow out from a port near the top of the vessel.

Alternatively, it is known to inject a coagulant into a water inflow pipe just prior to feeding the water into a lake. This may be accomplished, for example, using a flow proportional injection of coagulant into a stormwater inlet pipe, or by injecting the coagulant into a pipe as it feeds into a wetland. In these cases, the floc accumulates in the lake or wetland over time. In yet another method, prior to entering the lake the floc is fed into a clarification or separation vessel, where the floc is captured and disposed of in a sanitary sewer or is used for land application.

Chemical treatment of both continuous-flow and variable-flow (e.g., agriculture and urban runoff) surface water sources typically is performed to protect downstream lakes, ponds, and streams from the adverse effects of high pollutant loads. The rainfall-driven runoff loads often vary widely in flow volume, and may also vary in chemical and physical composition. These varying flow volumes, along with fluctuations in the content of constituents (color, particulate matter, alkalinity) that influence coagulant effectiveness, often result in high and variable chemical dose requirements for coagulants, coagulant aids (e.g., polymers), and pH buffers.

Due to variable, and potentially high, surface water flows and complexities in coagulant dosing, techniques are needed to use chemicals in the most cost-effective manner. In conventional chemical treatment facilities, such as those used for drinking water treatment, the principal focus is to achieve rapid floc settling times, so as to minimize the size and capital cost of the settling vessels, which usually consist of concrete and steel clarifiers. By contrast, in situations such as agricultural settings, more area can be devoted to settling vessels (typically ponds).

For the above-mentioned “concrete and steel” systems, the goal is to achieve a certain pollutant outflow concentration. For the chemical treatment of stormwater feeding into a lake or wetland, the goal is typically focused on mass (or percentage) removal of contaminants. In all cases, however, there is a clear incentive to minimize chemical dose to minimize cost. In methods in which the floc is captured, another goal is to maximize the settling rate of the floc, which minimizes the “carry-over” of floc from the clarifier, since effective floc settling reduces the required size of the clarifier.

Floc that is pumped from a settling vessel typically is conveyed to a de-watering facility, consisting of a centrifuge, belt filter press, and/or drying bed. As a result of drying, the floc loses about 90-95% of its volume and increases markedly in bulk density. In conventional drinking water treatment facilities, the residual dried floc often is stored on-site, and ultimately is hauled away to a landfill for disposal. In the past two decades, however, it has been recognized that the residual dried floc resulting from the addition of metal salts has the additional ability to retain pollutants, such as P. Consequently, drinking water floc residuals have been transported from the treatment facility and spread on canal banks and re-flooded agricultural lands (being restored to wetlands) for the purpose of minimizing soil P export. Regardless of these beneficial uses, most floc residuals are still considered a solid waste that incur relatively expensive transport and disposal costs.

### SUMMARY

A method and system are provided for removing pollutants, such as heavy metals, phosphorus, and pathogenic organisms, from water. This method and system capitalize on the fact that coagulation and floc formation are dependent on the chemical characteristics of water (e.g., alkalinity, pH, dissolved organic matter) that are not necessarily related to the concentration of contaminants (e.g., phosphorus, heavy metals) desired to be removed from the water. A plurality of approaches can be used for exploiting this phenomenon. In a first system, a chemical coagulant is added to water containing a pollutant, the water being within an enclosure. The water and the coagulant are mixed, and coagulation and flocculation are permitted to occur. The mixing is stopped, and a floc formed by the coagulation and flocculation is permitted to settle to a bottom of the enclosure. The floc contains the pollutant, so that treated water remaining above the floc is thereby free from at least some of the pollutant.

At least some of the treated water is removed from the enclosure, and new water containing a pollutant is added to the enclosure. The new water and the floc are then mixed to resuspend components of the floc.

In a second system, a chemical coagulant is added to water containing a pollutant, the water being within an enclosure equipped with a matrix element. The water and the coagulant are mixed, and coagulation and flocculation are permitted to occur. The mixing is stopped, and a floc formed by the coagulation and flocculation is permitted to settle to a bottom of the enclosure, as well as onto the surfaces provided by the matrix element. The floc contains the pollutant, so that treated water remaining above the floc is thereby free from at least some of the pollutant.

At least some of the treated water is removed from the enclosure, and new water containing a pollutant is added to the enclosure. Pollutants in the newly added water encounter floc particles associated with the matrix element, which is deployed throughout the water column. Because these flocs still are somewhat “active” in terms of pollutant-removing capability, much of the pollutant mass subsequently is removed from the water. After several water exchanges, during which time the pollutant removal capability of these floc particles becomes depleted, another dose of coagulant is added to the enclosure and then mixed to form new flocs.

In a third system, a method is provided that minimizes chemical dosages by the reuse of dried floc material. This water-treatment method comprises adding a chemical coagulant to water containing a pollutant, wherein the water is within an enclosure. Coagulation and flocculation are permitted to occur, and a floc formed by the coagulation and flocculation is permitted to settle toward a bottom of the enclosure. The floc contains the pollutant, and thus treated water remaining above the floc is free from at least some of the pollutant.

At least some of the treated water is removed from the enclosure, and then at least some of the floc is removed from the enclosure. The removed floc is at least partially dewatered.

The dewatered floc is added to water in the enclosure in the form of, for example, particles. These particles remove phosphorus and settle, but do not create a new floc.

Another method for treating water comprises mixing a chemical coagulant with water containing a pollutant, permitting coagulation and flocculation to occur in an enclosure containing the water and coagulant, and permitting a floc formed by the coagulation and flocculation to settle toward a bottom of the enclosure. At least a portion of the floc can be resuspended using a mechanical mixing means positioned within the enclosure. Additional water containing a pollutant is added to the enclosure. A second floc is then permitted to form with the pollutant and the resuspended floc portion.

A further method for treating water comprises mixing a chemical coagulant with water containing a pollutant, permitting coagulation and flocculation to occur in an enclosure containing the water and coagulant, and permitting a floc formed by the coagulation and flocculation to settle toward a bottom of the enclosure. At least some of the treated water is exposed to a porous matrix, carbonate-based pH buffering agent, downstream from a site of floc settling, for reducing acidity of the treated water.

### BRIEF DESCRIPTION OF THE DRAWING

FIGS. 1A-1D is a side cross-sectional view of a vessel system, with the method steps illustrated as (FIG. 1A) pumping water into the vessel; adding a coagulant, mixing, and permitting a floc to form (FIG. 1B); halting the mixing and permitting the floc to settle (FIG. 1C); and pumping the treated water out of the vessel (FIG. 1D).

FIG. 2 is a side cross-sectional view of an enclosure system contained within a body of water.

FIG. 3 is a side cross-sectional view of a second embodiment.

FIGS. 4A-4D are schematic views of a third embodiment, with FIGS. 4A and 4B illustrating the coagulant addition into inflow piping (FIG. 4A) or into a mixing chamber (FIG. 4B) and resultant floc formation; FIG. 4C, floc dewatering; and FIG. 4D, dewatered floc addition to the enclosure.

FIGS. 5A,5B are side cross-sectional views of a fourth embodiment, with coagulant introduced either into the inflow (FIG. 5A) or into a mixing chamber (FIG. 5B), and the addition of a floc-recycling element within the enclosure.

FIG. 6 is a side cross-sectional view of a fifth embodiment, with the addition of a pH-buffering element within the enclosure.

### DETAILED DESCRIPTION

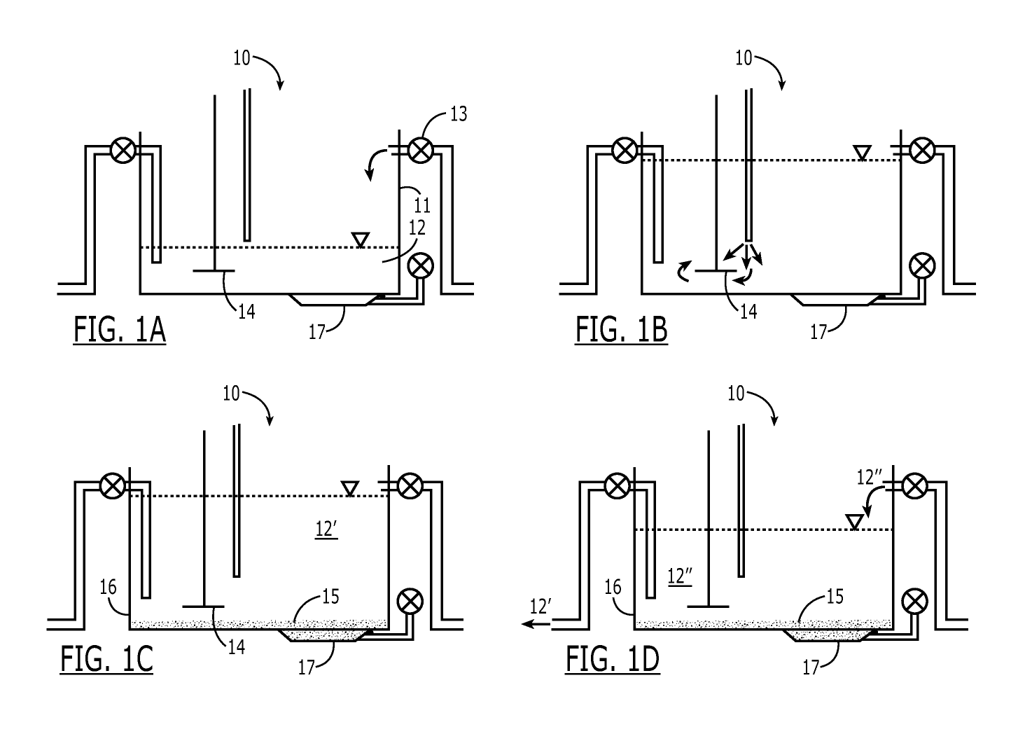

A description of preferred embodiments will now be presented with reference to FIGS. 1A-6.

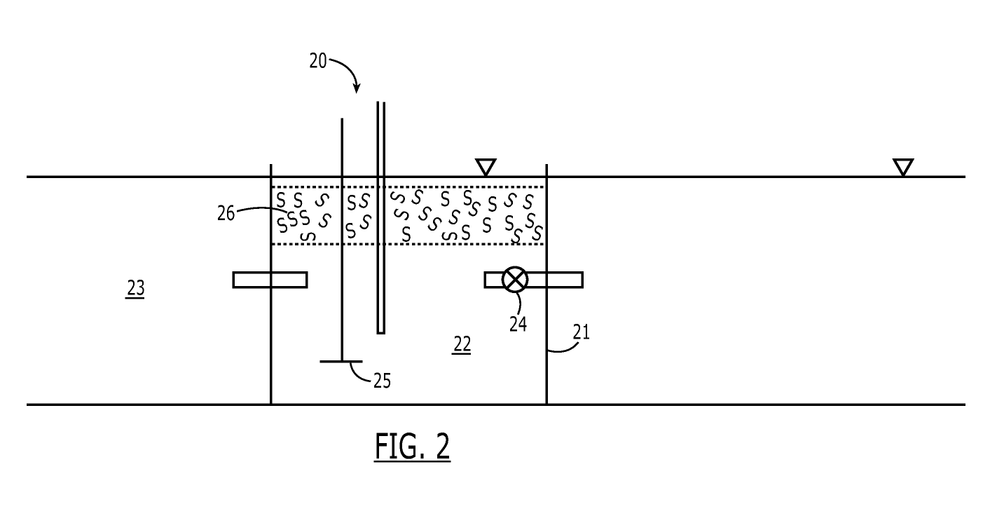

A first embodiment of the method of the present invention, using the systems 10,20 of FIGS. 1A-2, respectively, comprises the steps, illustrated in FIGS. 1A-1D, of feeding water to be treated, which may contain such contaminants as suspended solids, phosphorus, heavy metals, and pathogenic organisms, into an enclosure, which can be a free-standing tank 11 that holds the water to be treated 12 or an enclosure 21 that compartmentalizes a discrete water column 22 within a body of water 23 such as a lake. The feeding step (FIGS. 1A and 2) is typically performed by a pump 13,24, although this is not intended as a limitation, as a gravity-fed system may also be envisioned by one of skill in the art. The pump may be positioned within the enclosure 21 (pump 24 in FIG. 2) or outside the enclosure 11 (pump 13 in FIGS. 1A-1D).

Next a chemical coagulant, such as an aluminum, calcium, or iron compound (with chemical pH buffers or coagulant aids, as needed, which can be added prior to, contemporaneously, or after the coagulant), is added to the enclosure 11,21. The fluid in the enclosure is mixed using a mixing means 14,25, allowing coagulation and flocculation to occur (FIG. 1B). The mixing is stopped, and the floc 15 is allowed to settle to the bottom 16 of the enclosure 11, resulting in the removal of various pollutants from the water, which now reside in the floc 15 in the bottom of the enclosure 11.

Once the floc 15 is settled (FIG. 1C), the treated water column 12′ above the floc layer 15 is removed (FIG. 1D) and replaced with a fresh aliquot 12″ of contaminated water. This exchange may occur either quickly or slowly, and in a batch or continuous-flow basis. The floc 15 is left in place on the bottom 16 of the enclosure 11 during the exchange. Once the water exchange has been completed, the floc 15 is resuspended throughout the “fresh” water column 12″ by mixing the water in the enclosure 11.

Depending on the original concentration of the coagulant added, as well as the concentration of contaminants of the water, it is now likely that the resuspended floc 15 has additional capability to remove contaminants. The mixing is then stopped, and the new floc is allowed to settle to the bottom 16 of the enclosure 11. This process, including water exchange, resuspension of floc, and settling of floc, is repeated for several iterations, for as long as the floc continues to exhibit contaminant removal capability.

The floc ultimately is removed from the enclosure when its contaminant-removal capacity is exhausted, such as by pumping. In the case of enclosure 11, the vessel contains a sump 17 positioned adjacent the vessel's bottom 16 from which settled floc may be pumped at predetermined intervals.

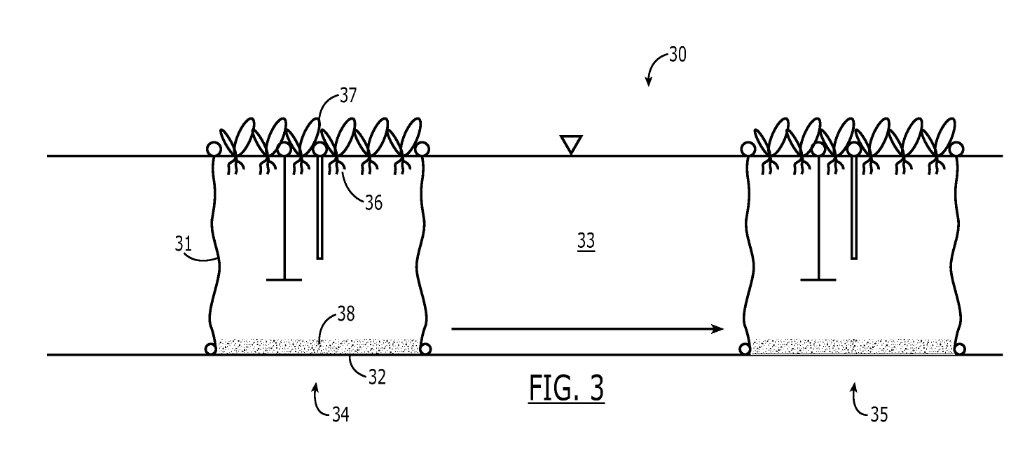

Enclosure 31 in another embodiment of the system 30 (FIG. 3) may comprise, for example, a flexible barrier having sides but no bottom. The bottom 32 here is thus the bottom of the body of water 33. The barrier 31 may be movable, in which case the process is carried out for a predetermined time with the barrier 31 at a first position 34. Following the predetermined time, the barrier 31 is moved to a second position 35 within the body of water 33 spaced apart from the first position 34, leaving the settled floc 38 at the first position 34 on the bottom 32.

In order to provide additional surface area, a matrix element may be added to the enclosure. The matrix element serves to provide a surface onto which floc can settle, this settled floc then providing additional floc-containing surface area in position to contact water to be treated.

In the embodiment 20 of FIG. 2, the matrix element 26 in one embodiment can comprise a plastic “trickling filter media” or baffle such as are known in the art. In another embodiment, the matrix element 26 can comprise a bristle media filter, such as typically used for air filtration. In the embodiment 30 of FIG. 3, the matrix element comprises a root mat 36 of floating vegetation 37, which can, for example, be pre-inoculated with floc.

In the embodiment 30 of FIG. 3, if the body of water 33 has a natural (e.g., soil, sand) bottom 32, the body of water 33 may be periodically drained, and the vegetation 37, floc associated with the root mat 36, and settled floc 38 on the bottom 32 tilled into the natural bottom 32.

In all cases, the overall process is re-started by adding coagulant dose (similar to the original dose) to a fresh parcel of water, thereby forming a “new” aliquot of floc. Under certain circumstances, the contaminant removal performance of the resuspended floc can be enhanced by adding a small dose of pH buffer, coagulant aid (e.g., a polymer), and/or coagulant (typically at a much lower concentration than the original dose), upon resuspension of the floc in the enclosure.

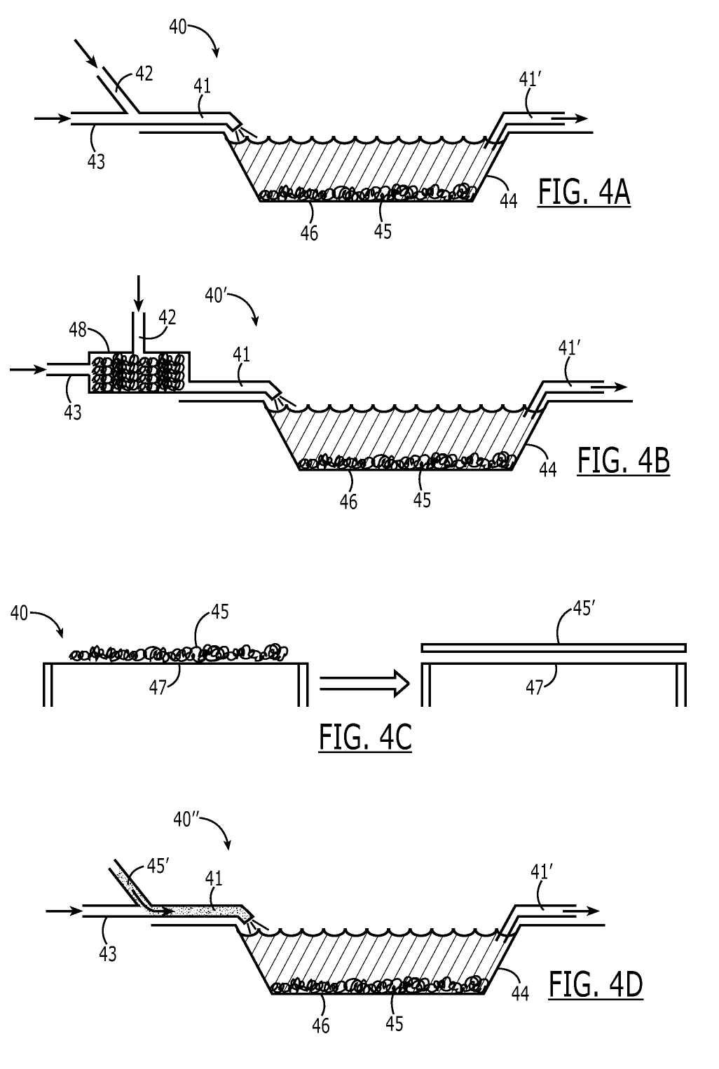

In a third embodiment (FIGS. 4A-4D), a system 40,40′,40″ and method are provided for treating water 41 that comprises adding a chemical coagulant 42 to water 41 containing a pollutant, wherein the water 41 is directed via, for example, piping 43 to an enclosure 44 (FIG. 4A). The coagulant can comprise, for example, at least one of an aluminum, a calcium, and an iron compound, and the pollutant can comprise at least one of a suspended solid, phosphorus, a heavy metal, a nitrogen compound, and a pathogenic organism. The enclosure 44 can comprise a discrete column of water within a body of water, as discussed above, or comprise an enclosure 44 used for the purpose of the present method 40. The coagulant stream 42 can mix within the inflow piping 43 (FIG. 4A). In an alternative system 40′ (FIG. 4B), the coagulant stream 42 can be mixed with incoming water in a mixing chamber 48 upstream of the enclosure 44 to facilitate coagulation.

Coagulation and flocculation are permitted to occur in substantially quiescent conditions, and a floc 45 formed by the coagulation and flocculation is permitted to settle toward a bottom 46 of the enclosure 44. The floc 45 contains the pollutant, and thus treated water 41′ remaining above the floc 45 is free from at least some of the pollutant.

The floc 45 has been found to have additional ability to remove pollutants, owing to the presence of unoccupied binding sites that can adsorb contaminants such as P. In the past, this floc 45 has been considered problematic, since it has a high water content, but low bulk density, and quickly accrues in and fills up the enclosure 44, which reduces effective storage room in the enclosure 44 and hydraulic retention time. As in an embodiment discussed above, the floc 45 can be resuspended and employed to yield additional flocculation to occur. Also as above, the water addition can be performed substantially continuously or in batch mode. Also one or both of a pH buffer and a coagulant aid can be added following the addition of the coagulant.

At least some of the treated water 41′ can be removed from the enclosure 44, and at least some of the floc 45 can be removed from the enclosure 44. The removed floc 45 is at least partially dewatered (FIG. 4C) at a floc drying device, for example, a drying bed 47, or possibly a mechanical device such as a belt filter press or centrifuge. Such a drying facility can be established adjacent the enclosure 44. The wet floc 45 can be conveyed to the drying facility on either a continuous or intermittent basis.

In a system 40″ and method, the dried floc 45′ can be re-introduced into the treatment system 44 (FIG. 4D), with its residual pollutant- (e.g., P) removing ability further harnessed for treatment of the water 41. Approaches for dried floc 45′ re-introduction/reuse include: addition to the inflow water stream 43, either alone or in conjunction with a coagulant, coagulant aid, or a buffer; and addition to the inflow and/or other region(s) of the vessel 44, so that it is distributed throughout the water column and settles adjacent the vessel bottom 46. The dried floc 45′ can be added, for example, in particulate form, although this is not intended as a limitation. The location in the vessel 44 of dried floc introduction may either be shallow or deep, and vegetated or non-vegetated. The dried floc 45′ can serve to immobilize P in the water column itself, and/or to immobilize sediment P, to prevent it from re-entering the water column, by forming settled material 45″ adjacent the enclosure bottom 46.

It should be noted that, due to the marked volume reduction achieved by the floc upon drying, the volume occupied by the re-introduced dry residual floc 45′ is minimal, so that it occupies little of the water column. In a vessel of relatively large area and volume, such as a pond, the system 40,40′,40″ can operate for years (perhaps decades) without requiring any off-site transport/disposal of residual floc. In this respect, it is a sustainable system, maximizing use of the chemical coagulant to the greatest extent possible, and eliminating the need for off-site disposal of residual solid wastes.

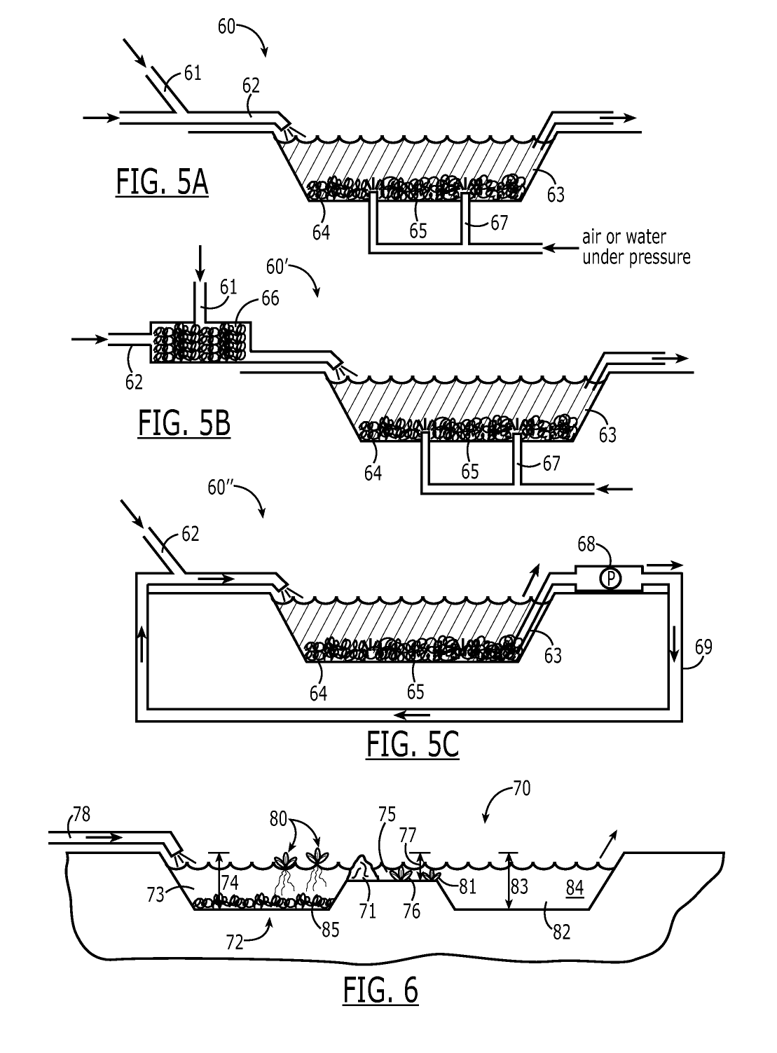

Another embodiment 60,60′,60″ (FIGS. 5A-5C) can comprise a sequential system having a plurality of elements. In systems 60,60′ (FIGS. 5A,5B), a coagulant 61 is added to the inflowing water stream 62 directed toward a vessel or pond 63. After appropriate mixing within the inflow piping 62 (FIG. 5A) or in a specialized mixing chamber 66 (FIG. 5B) to facilitate coagulation, the water and coagulant mixture enters the vessel or pond 63. In the quiescent conditions of the settling basin 63, the resulting floc material 64 settles to the bottom 65 of the vessel 63.

As noted previously, following settling, the floc material 64 typically has additional ability to remove pollutants, due to the presence of unoccupied binding sites that can adsorb constituents such as P. This settled floc material 64 can essentially be “re-used,” that is, exposed to fresh, unamended aliquots of water, to achieve additional pollutant removal.

One technique for accomplishing floc re-use is to mechanically disturb the floc 64 settled in the vessel 63 by aeration or jets of water 67. During, or just prior to, this resuspension of floc 64, an aliquot of untreated water is introduced into the vessel 63, so that the unamended water can come into contact with the floc particles. In system 60″ (FIG. 5C) at least some of the floc 64 can be removed from the vessel 63 (via suction removal and transport by a pump 68) and conveyed 69 directly into the inflow piping 62, where it encounters untreated water.

Additionally, floc re-use can be accomplished passively by allowing it to settle onto the vessel bottom 65 or onto a matrix element in the water column, and leaving it in place so that it can contact fresh, unamended aliquots of water that are introduced into the vessel.

The active re-use of previously settled flocs can be performed at time intervals ranging from hours to months, since investigations have demonstrated that this floc 64 retains its P sorption ability for at least six months. It should be noted that the active re-use of floc (e.g., resuspension) may increase the amount of “clarifier” area and volume required for settling, and this can be provided as one large vessel or pond, a vessel compartmentalized by floating booms and flexible barriers, or as sequential vessels connected by a culvert or open ditch. Moreover, as a result of “active” re-use, additional doses of a coagulant or a coagulant aid, such as a polymer, may be needed to be added to facilitate settling of the resuspended or re-used floc. Despite the potential need for coagulant aid additions, the re-use of previously settled floc in either an active or passive manner effectively maximizes the amount of pollutant that can be removed per unit mass of active chemical added.

One challenge for chemical-based surface water treatment systems is that they typically are not allowed to discharge acidic waters. As noted above, owing to the likely fluctuations of inflow color and alkalinity in surface water runoff streams, the buffer requirements associated with acidic metal coagulants can be high (and expensive) and dosing approaches complex.

In yet a further embodiment 70 (FIG. 6), outflow acidity can be addressed in a cost-effective manner by positioning a porous limerock (LR) or shellrock outcropping, berm 71, or levee, situated within a vessel 72 or pond downstream of a settling zone 73 for floc 85 having a first depth 74. The porous limerock berm 71 can be situated, for example, in a pH-treatment zone 75 downstream of the floc settling zone 73. In an exemplary embodiment, the limerock berm 71 can be positioned adjacent a bottom 76 of the pH-treatment zone 75 having a second depth 77 less than the first depth 74. Thus, clarified water can move from the floc settling zone 73 across the limerock 71 and experience pH buffering.

When the acidic supernatant resulting from upstream coagulant addition 79 and floc recycling is passed through the limerock 71, alkalinity (primarily carbonate ions) and associated cations such as calcium and magnesium dissolve in the acidic stream, resulting in an increase in pH. The degree of acidity of the inflow stream 78 dictates the exposure requirement to limerock, which can be controlled by the size of limerock berm 71, as well as the flow rate and hydraulic retention time within the limerock bed. It should be noted that the limerock material that comprises the bed will dissolve over time, which will require the periodic replacement of a portion or all of the rock.

The use of vegetation in an optional element in this system 70. In an exemplary embodiment, floating plants 80 can be positioned in a downstream portion of the floc-settling zone 73, and/or submerged plants 81 can be positioned in or downstream of the pH-treatment zone 75, although these are not intended as limitations.

Another optional feature of this system 70 comprises a third region 82 having a third depth 83 greater than the second depth 77. This third region 82 can serve as a settling zone to further clarify the treated water 84.

The methods disclosed herein may be performed “manually” or under electronic control, wherein the pumping and mixing elements are under timer control and are coordinated to perform the method steps automatically.

One of the benefits of the present systems and methods is that, by harnessing the “additional” contaminant removal capability of a previously formed and settled floc through its subsequent resuspension and/or drying and re-introduction, the mass of pollutant removed per unit mass of coagulant added can be maximized. This represents a cost savings (reduction in operating costs for coagulant purchase), and in many circumstances, an environmental benefit (reduction of coagulant/floc that ultimately is discharged to the environment).

Another benefit of the current systems and methods is that only one enclosure is required, since it is not critical to achieve a predetermined target outflow concentration.

One of skill in the art will recognize that each body of water and its components will have its own characteristics. Therefore, each site will be evaluated to determine individual design and operational variables, including, but not intended to be limited to, type and dose of coagulant, buffers and coagulant aids; frequency of water exchange; frequency of floc resuspension; dose of additional coagulant, buffer and coagulant aids, at the time of floc resuspension; and method of removing floc.

What is claimed is:

1. A method for treating water comprising:
(a) mixing a chemical coagulant with water containing a pollutant;
(b) permitting coagulation and flocculation to occur in an enclosure containing the water and coagulant;
(c) permitting a floc formed by the coagulation and flocculation to settle toward a bottom of the enclosure, the floc containing at least some of the pollutant, treated water remaining above the floc thereby free from the at least some of the pollutant;
(d) removing at least some of the treated water from the enclosure;
(e) removing at least some of the floc from the enclosure;
(f) dewatering the removed floc;
(g) adding the dewatered floc to water in or entering the enclosure; and
(h) permitting the dewatered floc to absorb additional pollutant from the water to which the dewatered floc is added.

2. The method recited in claim 1, further comprising, following (d):
(i) adding new water containing a pollutant to the enclosure;
(j) mixing the new water and the floc to resuspend components of the floc;
(k) permitting coagulation and flocculation to occur; and
(l) permitting a floc formed by the coagulation and flocculation to settle to a bottom of the enclosure, the floc containing the pollutant, treated water remaining above the floc thereby free from at least some of the pollutant.

3. The method recited in claim 2, wherein (d) and (i) are performed in one of a batch mode or a substantially continuous mode.

4. The method recited in claim 2, further comprising repeating (i)-(l) until a contaminant removal capability of the floc is substantially exhausted.

5. The method recited in claim 1, further comprising, prior to (a), adding to the enclosure at least one of a pH buffer and a coagulant aid.

6. The method recited in claim 1, wherein (a) comprises adding the coagulant to one of an inflow stream of the water and to the water in a mixing chamber upstream of the enclosure.

7. The method recited in claim 1, wherein the coagulant comprises at least one of an aluminum, a calcium, and an iron compound.

8. The method recited in claim 1, wherein the pollutant comprises at least one of a suspended solid, phosphorus, a heavy metal, a nitrogen compound, and a pathogenic organism.

9. The method recited in claim 1, wherein the enclosure comprises a discrete column of water within a body of water.

10. The method recited in claim 9, further comprising (i) pumping new water into the water column from the body of water, and wherein (d) comprises pumping the treated water out of the water column back into the body of water.

11. The method recited in claim 10, wherein (d) and (i) are performed in one of a batch mode or a substantially continuous mode.

12. The method recited in claim 10, wherein the enclosure comprises a movable, substantially vertical barrier located at a first position within the body of water, a bottom of the water column comprising a bottom of the body of water, and further comprising:
(j) permitting the floc to settle to the water body bottom; and
(k) periodically moving the vertical barrier to a second position within the water body spaced apart from the first position, leaving the settled floc at the water body bottom of the first location.

13. The method recited in claim 1, wherein the enclosure comprises a body of water and the enclosure bottom comprises a natural bottom, and further comprising:
(i) periodically draining the body of water; and
(j) tilling the floc into the natural bottom of the body of water.

14. A method for treating water comprising:
mixing a chemical coagulant with water containing a pollutant;
permitting coagulation and flocculation to occur in an enclosure containing the water and coagulant;
permitting a floc formed by the coagulation and flocculation to settle toward a bottom of the enclosure, the floc containing at least some of the pollutant, treated water remaining above the floc thereby free from the at least some of the pollutant;
resuspending at least a portion of the floc;
adding additional water containing a pollutant to the enclosure; and
permitting an enhanced floc to form with the pollutant and the resuspended floc portion.

15. The method recited in claim 14, wherein the mixing comprises adding the coagulant to one of an inflow stream of the water and to the water in a mixing chamber upstream of the enclosure.

16. The method recited in claim 14, wherein the resuspending comprises mechanically disturbing the at least a portion of the floc by mechanically mixing the floc within the enclosure.

17. The method recited in claim 16, wherein the mechanically mixing comprises introducing at least one of a gas and a liquid under pressure adjacent the floc.

18. The method recited in claim 14, wherein the resuspending comprises removing at least a portion of the floc from the enclosure and introducing at least part of the removed floc into the water upstream of the enclosure.

19. A method for treating water comprising:
mixing a chemical coagulant with water containing a pollutant;
permitting coagulation and flocculation to occur in an enclosure containing the water and coagulant;
permitting a floc formed by the coagulation and flocculation to settle toward a bottom of the enclosure, the floc containing at least some of the pollutant, treated water remaining above the floc thereby free from the at least some of the pollutant; and
exposing at least some of the treated water to an alkalinity-enhancing, pH buffering agent downstream of a site of floc settling, for reducing an acidity of the treated water.

20. The method recited in claim 19, wherein the pH buffering agent comprises a porous matrix, carbonate-based element.

21. The method recited in claim 20, wherein the carbonate-based element comprises at least one of limerock and shellrock.

22. The method recited in claim 19, wherein:
the enclosure has a first depth in a floc-settling zone;
the enclosure has a second depth less than the first depth in a pH-treatment zone downstream of the floc-settling zone; and
the pH buffering agent is positioned within the pH-treatment zone.

23. The method recited in claim 22, wherein the enclosure further comprises a settling zone downstream of the pH-treatment zone, the settling zone having a third depth greater than the second depth, and further comprising permitting water entering the settling zone to clarify and removing the clarified water from the settling zone.

24. The method recited in claim 19, further comprising placing aquatic plants in at least one of a downstream portion of the floc-settling zone and the pH-treatment zone.

25. The method recited in claim 19, wherein the aquatic plants comprise floating plants in the floc-settling zone and submerged plants in the pH-treatment zone.
